(19) United States
(12) Patent Application Publication
(10) Pub. No.: US 2007/0229020 A1
(43) Pub. Date: Oct. 4, 2007

(54) Multi-speed permanent split capacitor motors

(76) Inventors: Donald E. Morgan, Florissant, MO (US); Joel W. Northwall, St. Charles, MO (US)

Correspondence Address: HARNESS, DICKEY, & PIERCE, P.L.C, 7700 BONHOMME, STE 400, ST. LOUIS, MO, 63105, US

(21) Appl. No.: 11/396,422

(22) Filed: Mar. 31, 2006

(51) Int. Cl. H02P 1/26

(52) U.S. Cl. 318/794

(57) ABSTRACT

A multi-speed permanent split capacitor (PSC) motor includes a first winding circuit having an auxiliary winding and a main winding, a second winding circuit having an auxiliary winding and a main winding, a capacitor and a switching device. The switching device is configured to selectively couple the capacitor to the auxiliary winding of the first winding circuit to operate the motor at a first pole speed, and to selectively couple the capacitor to the auxiliary winding of the second winding circuit to operate the motor at a second pole speed. The switching device also open-circuits the inoperative winding circuit during operation of a different winding circuit to interrupt re-circulating current and the associated generated loads caused by any induced voltages.

### FIELD

The present disclosure relates to electric motors including permanent split capacitor (PSC) motors having multiple speeds.

### BACKGROUND

The statements in this section merely provide background information related to the present disclosure and may not constitute prior art.

A variety of multi-speed electric motors are known in the art that employ capacitors to achieve multi-speed operation. Some of these motors employ at least one start capacitor for starting the motor and at least one run capacitor for running the motor, once started. The start capacitor is often an electrolytic capacitor and the run capacitor is often an oil-filled capacitor.

Additionally, some of these motors include a speed-dependent mechanical actuator coupled to a mechanical switch for energizing a start circuit during starting, and for energizing one or more run circuits (and run capacitors) thereafter. The position of the mechanical switch is controlled by the speed-dependent actuator. During starting, the mechanical switch engages a first set of contacts to energize the start circuit. Thereafter, as the motor speed increases, centrifugal force acting on the speed-dependent actuator will cause the mechanical switch to switch from the first set of contacts to a second set of contacts for opening the start circuit and/or energizing a run circuit.

As recognized by the present inventors, these known motors suffer several disadvantages. For example, a mechanical switch could weld due to continuous arcing, resulting in damage to the motor windings and/or capacitors in the starting circuits. Further, because speed-dependent actuators typically include mechanical parts such as spools, springs and weights, such actuators are also subject to wear and could cease to work properly over time, which could make the motor inoperable. In addition, electrolytic capacitors have a tendency for the electrolyte to dry out prematurely in high temperature environments, such as spas and pool applications, which could cause the start capacitor to not function properly.

### SUMMARY

According to one aspect of the present disclosure, a multi-speed permanent split capacitor motor includes a first winding circuit having an auxiliary winding and a main winding, a second winding circuit having an auxiliary winding and a main winding, a capacitor and a switching device. The switching device is configured to selectively couple the capacitor to the auxiliary winding of the first winding circuit to operate the motor at a first pole speed, and to selectively couple the capacitor to the auxiliary winding of the second winding circuit to operate the motor at a second pole speed.

According to another aspect of the present disclosure, a multi-speed permanent split capacitor motor includes a first speed winding circuit having an auxiliary winding and a main winding, a second speed winding circuit having an auxiliary winding and a main winding, and a switching device. The switching device is configured to open-circuit the first speed winding circuit when the motor is operating at the second speed, and to open-circuit the second speed winding circuit when the motor is operating at the first speed.

According to yet another aspect of the present disclosure, a two-speed permanent split capacitor motor includes a two-pole winding circuit and a four pole winding circuit. Each winding circuit has a main winding and an auxiliary winding. The motor further includes a capacitor and a relay. The relay is configured to selectively couple the capacitor in series with the auxiliary winding of the two-pole winding circuit to operate the motor at a two-pole speed, and to selectively couple the capacitor in series with the auxiliary winding of the four-pole winding circuit to operate the motor at a four-pole speed.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a circuit diagram of a stator circuit for a multi-speed PSC motor according to one embodiment of the present disclosure.

FIGS. 2A and 2B are circuit diagrams illustrating operation of the switching device shown in FIG. 1.

FIG. 3 is a circuit diagram of a stator circuit for a two-speed PSC motor according to another embodiment of the present disclosure.

FIG. 4 is a perspective view of a spa having a pump assembly according to another embodiment of the present disclosure.

FIG. 5 is a perspective view of a swimming pool having a pump assembly according to another embodiment of this disclosure.

Throughout the drawings, corresponding reference numerals indicate like or corresponding parts and features.

### DETAILED DESCRIPTION

The following description is merely exemplary in nature and is not intended to limit the scope of this disclosure nor its potential applications.

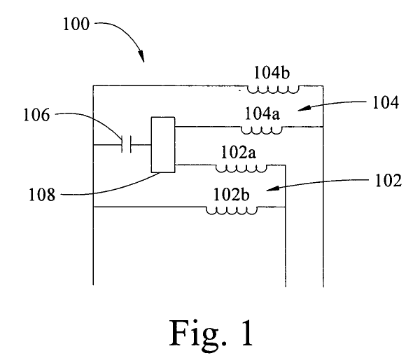

A stator circuit for a multi-speed PSC motor according to one embodiment of the present disclosure is illustrated in FIG. 1 and indicated generally by reference numeral 100. As shown in FIG. 1, the stator circuit 100 includes a first winding circuit 102 having an auxiliary winding 102a and a main winding 102b, and a second winding circuit 104 having an auxiliary winding 104a and a main winding 104b. The stator circuit 100 further includes a capacitor 106 and a switching device 108.

The switching device 108 is configured to selectively couple the capacitor 106 to the auxiliary winding 102a of the first winding circuit 102 to operate the motor 100 at a first pole speed. Further, the switching device 108 is configured to selectively couple the capacitor 106 to the auxiliary winding 104a of the second winding circuit 104 to operate the motor 100 at a second pole speed. In this manner, the stator circuit 100 can operate at two different pole speeds using only one capacitor 106. The stator circuit 100 of FIG. 1 therefore requires fewer parts than, for example, a stator circuit employing a dedicated capacitor for each winding circuit.

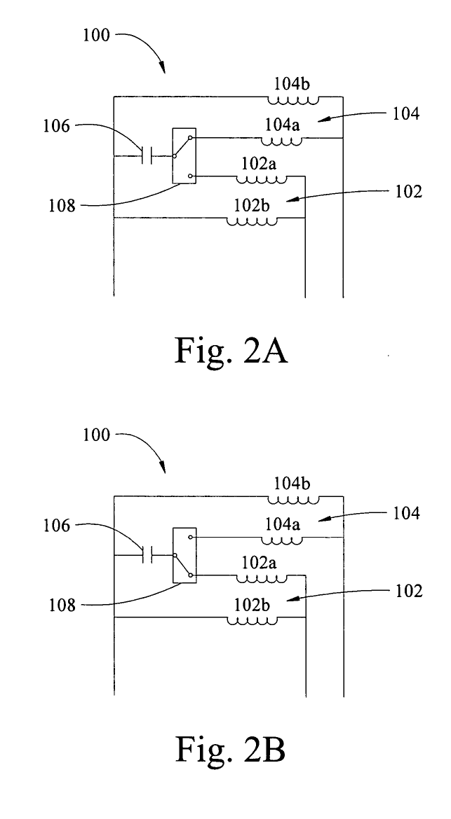

In the specific embodiment of FIG. 1, the switching device 108 provides the additional benefit of open-circuiting one of the winding circuits 102, 104 when coupling the capacitor 106 to the auxiliary winding of the other winding circuit. This is illustrated generally in FIGS. 2A and 2B. In FIG. 2A, the switching device 108 couples the capacitor 106 to the auxiliary winding 104a while open-circuiting winding circuit 102. Conversely, in FIG. 2B, the switching device 108 couples the capacitor 106 to the auxiliary winding 102a while open-circuiting winding circuit 104. Open-circuiting winding circuit 104 interrupts re-circulating current that would be created by induced voltages during operation of winding circuit 102. Interrupting the current in winding circuit 104 also eliminates any associated generated loads during operation of the other winding circuit 102, which could otherwise create a cusp in the torque produced by the winding circuit 102.

Although the benefit of open-circuiting one of the winding circuits is described and illustrated in conjunction with switching the capacitor 106 between two (or more) winding circuits 102, 104, the teachings of this disclosure are not so limited. For example, if the capacitor 106 in FIG. 1 was replaced with a first capacitor dedicated to winding circuit 102 and another capacitor dedicated to winding circuit 104, the switching device 108 could still be employed to open-circuit, for example, winding circuit 104 during operation of winding circuit 102 to interrupt re-circulating current caused by induced voltages in winding circuit 104.

With further reference to FIG. 1, the winding circuits 102, 104 can each be configured for any desired pole speed. For example, windings 102a, 102b can be two-pole windings such that winding circuit 102 is configured for two-pole operation, and windings 104a, 104b can be four-pole windings such that winding circuit 104 is configured for four-pole operation. It should be understood, however, that other pole speeds and pole speed combinations can be employed without departing from the scope of this disclosure. Further, additional winding circuits can be added to the stator circuit 100 of FIG. 1 to support additional (i.e., more than two) pole speeds. Thus, while only two-speed motor designs are shown in the drawings, the present disclosure is not so limited.

Those skilled in the art will appreciate that capacitor 106 can be any suitable type of capacitor, and that switching device 108 can be any suitable type of switching means including but not limited to electronic switches, relays, etc. Further, while only one capacitor 106 is shown in FIG. 1, it should be understood that additional (shared or dedicated) capacitors can be employed if desired without departing from the scope of this disclosure. Additionally, it should be understood that the switching device 108 may itself comprise multiple switch devices.

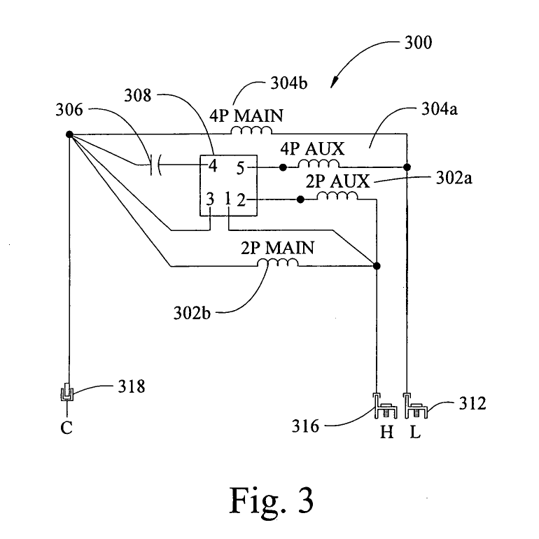

FIG. 3 illustrates a stator circuit 300 for a two-speed PSC motor according to another embodiment of this disclosure. As shown in FIG. 3, the stator circuit 300 is configured for 2-pole and 4-pole operation. More specifically, the circuit 300 includes a two pole auxiliary winding 302a, a two pole main winding 302b, a four pole auxiliary winding 304a and a four pole main winding 304b. The stator circuit 300 further includes a capacitor 306, and a relay 308 for selectively coupling the capacitor 306 in series with the two-pole auxiliary winding 302a or the four-pole auxiliary winding 304a. In the particular embodiment of FIG. 3, the relay 308 includes a coil (not shown) connected between contacts 1 and 3; contacts 4 and 5 are normally closed, and contacts 4 and 2 are normally open.

As shown in FIG. 3, the relay 308 is configured such that when the high speed terminal 316 is energized (by applying a voltage across the high speed terminal 316 and a common terminal 318), the capacitor 306 is coupled to the two pole auxiliary winding 302a. During this time, the four pole winding circuit 304 is open-circuited. When the low speed terminal 312 is energized (by applying a voltage across the low speed terminal 312 and the common terminal 318), the capacitor 306 is coupled to the four pole auxiliary winding 304a and the two pole winding circuit 302 is open-circuited.

In the specific embodiment of FIG. 3, the capacitor 306 is an oil-filled capacitor. However, other types of capacitors can be employed without departing from the teachings of this disclosure. Additionally, in this particular embodiment, a motor speed of approximately 3450 rpm is achieved during two-pole operation, and a motor speed of approximately 1725 rpm is achieved during four-pole operation. The stator circuit 300 can be configured for operation using any common single phase voltage, as apparent to those skilled in the art.

It should be noted that the stator circuit 300 illustrated in FIG. 3 does not employ an electrolytic capacitor, nor does it employ a speed-dependent actuator for controlling the position of a mechanical switch. Accordingly, a PSC motor including the stator circuit 300 of FIG. 3 will have improved reliability as compared to motors employing one or more of such components.

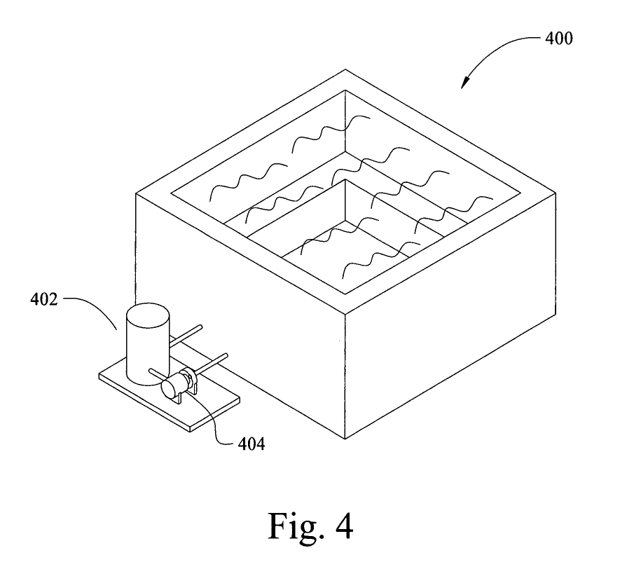

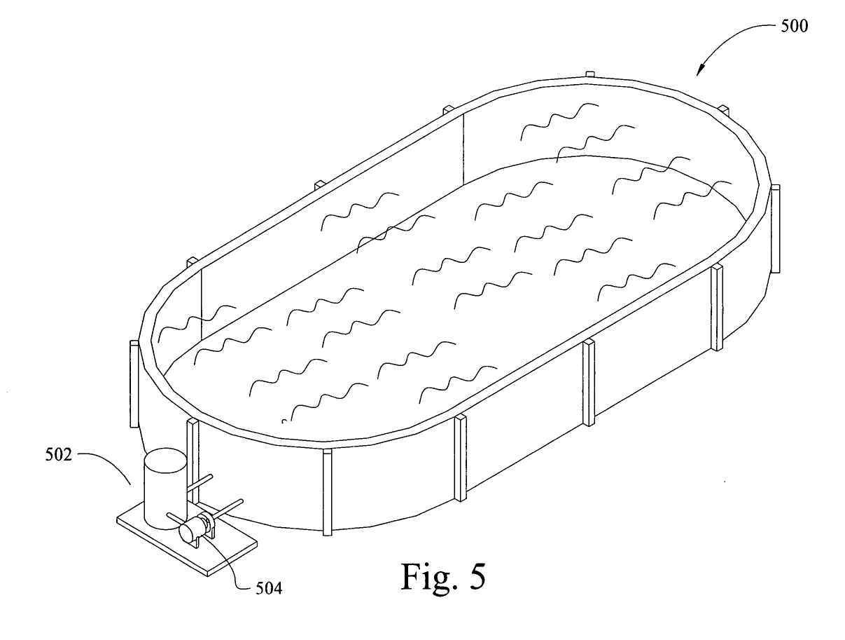

The teachings of this disclosure can be applied to a wide variety of applications. One such application is in fluid (e.g., air and/or liquid) pump assemblies, including pump assemblies for swimming pools and spas (including hot tubs and whirlpool baths). FIG. 4 illustrates a spa 400 having a pump assembly 402, including a pump motor 404, for circulating water. Similarly, FIG. 5 illustrates a pool 500 having a pump assembly 502, including a pump motor 504, for circulating water. The motors 404, 504 are preferably multi-speed PSC motors having one or more of the features described above with reference to FIGS. 1-3.

What is claimed is:

1. A multi-speed permanent split capacitor motor comprising a first winding circuit having an auxiliary winding and a main winding, a second winding circuit having an auxiliary winding and a main winding, a capacitor, and a switching device configured to selectively couple the capacitor to the auxiliary winding of the first winding circuit to operate the motor at a first pole speed, and to selectively couple the capacitor to the auxiliary winding of the second winding circuit to operate the motor at a second pole speed.

2. The motor of claim 1 wherein the switching device is configured to open-circuit the first winding circuit when the capacitor is coupled to the second winding circuit, and to open-circuit the second winding circuit when the capacitor is coupled to the first winding circuit.

3. The motor of claim 2 wherein the switching device is a relay.

4. The motor of claim 3 wherein the capacitor is a run capacitor.

5. The motor of claim 3 wherein the capacitor is an oil-filled capacitor.

6. The motor of claim 5 wherein the motor does not include a capacitor used exclusively by the first winding circuit or the second winding circuit.

7. The motor of claim 6 wherein the first winding circuit is a two-pole winding circuit and the second winding circuit is a four-pole winding circuit.

8. A pump assembly comprising the motor of claim 7.

9. A pool comprising the pump assembly of claim 8.

10. A spa comprising the pump assembly of claim 8.

11. A multi-speed permanent split capacitor motor comprising a first speed winding circuit having an auxiliary winding and a main winding, a second speed winding circuit having an auxiliary winding and a main winding, and at least one switching device configured to open-circuit the first speed winding circuit when the motor is operating at the second speed, and to open-circuit the second speed winding circuit when the motor is operating at the first speed.

12. The motor of claim 11 wherein the motor does not include an actuator operated mechanical switch.

13. The motor of claim 12 wherein the motor does not include a speed-dependent mechanical actuator.

14. The motor of claim 13 wherein the motor is a single phase motor.

15. A two-speed permanent split capacitor motor comprising a two-pole winding circuit and a four-pole winding circuit each including a main winding and an auxiliary winding, a capacitor, and a relay configured to selectively couple the capacitor in series with the auxiliary winding of the two-pole winding circuit to operate the motor at a two-pole speed, and to selectively couple the capacitor in series with the auxiliary winding of the four-pole winding circuit to operate the motor at a four-pole speed.

16. The motor of claim 15 wherein the relay is further configured to open the two-pole winding circuit when the motor is operating at the four-pole speed, and to open the four-pole winding circuit when the motor is operating at the two-pole speed.

17. The motor of claim 15 wherein the capacitor is an oil-filled capacitor.
